(19) United States
(12) Patent Application Publication
(10) Pub. No.: US 2012/0084632 A1
(43) Pub. Date: Apr. 5, 2012

(54) METHOD AND APPARATUS FOR INSERTING ADDRESS OF HYPERLINK INTO BOOKMARK

(75) Inventors: Eun-young LIM, Seoul (KR); Ji-sun Yang, Incheon (KR); Sin-oug Yeo, Seoul (KR)

(73) Assignee: Samsung Electronics Co., Ltd., Suwon-si (KR)

(21) Appl. No.: 13/252,681

(22) Filed: Oct. 4, 2011

(30) Foreign Application Priority Data
Oct. 4, 2010 (KR) 10-2010-0096517

(51) Int. Cl. G06F 17/20

(52) U.S. Cl. 715/206

(57) ABSTRACT

A method of inserting an address of a hyperlink into a bookmark is provided, including selecting a portion of a document; analyzing a plurality of hyperlinks contained in the selected portion; extracting at least one address from the analyzed hyperlinks; and inserting the extracted addresses into the bookmark.

### PRIORITY

This application claims priority to Korean Patent Application No. 10-2010-0096517, filed on Oct. 4, 2010 in the Korean Intellectual Property Office, the entire disclosure of which is incorporated herein by reference.

### BACKGROUND OF THE INVENTION

1. Field of the Invention

The present invention relates generally to a method and apparatus for inserting an address of a hyperlink into a bookmark, and more particularly, to a method and apparatus for extracting a hyperlink contained in a document and inserting an address contained in the extracted hyperlink into a bookmark.

2. Description of the Related Art

Recently, Internet use and the use of content via the Internet are increasing. Thus, an effective access to and management of various kinds of web content is necessary. Additionally, the enforcement of a convergence function makes connection and data sharing between devices easy. Accordingly, the use of the Internet has been expanding to include home appliances, such as TeleVisions (TVs) and mobile devices, aside from personal computers. Thus, a new method of using web content suitable for the home appliances is required.

### SUMMARY OF THE INVENTION

The embodiments of the present invention provide a method of access to, searching for, and storing web content, which is easy to use even in home appliances aside from personal computers, and more specifically, a method of inserting an address of a hyperlink into a bookmark, whereby a plurality of bookmarks can be grouped and inserted without opening a webpage by extracting a hyperlink in a portion of the webpage, that is, a method of easily inserting and searching for a bookmark during web surfing, and an apparatus therefor.

According to an aspect of the present invention, a method of inserting an address of a hyperlink into a bookmark is provided, the method including selecting a portion of a document; analyzing a plurality of hyperlinks included in the selected portion; extracting at least one address from the analyzed hyperlinks; and inserting the extracted addresses into the bookmark.

According to another aspect of the present invention, an apparatus for inserting an address of a hyperlink into a bookmark is provided, the apparatus including an area selector for selecting a portion of a document; a hyperlink analyzer for analyzing a plurality of hyperlinks contained in the selected portion and extracting at least one address from the analyzed hyperlinks; and a controller for inserting the extracted addresses into the bookmark.

### BRIEF DESCRIPTION OF THE DRAWINGS

The above and other features and advantages of the present invention will become more apparent by describing in detail embodiments thereof with reference to the attached drawings in which:

FIG. 1 is a flowchart illustrating a method of inserting an address of a hyperlink into a bookmark, according to an embodiment of the present invention;

FIG. 2 illustrates a webpage, according to an embodiment of the present invention;

FIG. 3 illustrates a structure of a selected portion including hyperlinks, according to an embodiment of the present invention;

FIG. 4 illustrates a structure of a group inserted in a bookmark, according to an embodiment of the present invention;

FIG. 5 illustrates bookmarks in which addresses of hyperlinks are inserted, according to an embodiment of the present invention;

FIGS. 6A and 6B further illustrate FIG. 5;

FIG. 7 is a flowchart illustrating a method of deleting a inserted bookmark, according to an embodiment of the present invention;

FIG. 8 illustrates a method of deleting a inserted bookmark, according to an embodiment of the present invention; and

FIG. 9 illustrates a block diagram of an apparatus for inserting an address of a hyperlink into a bookmark, according to an embodiment of the present invention.

### DETAILED DESCRIPTION OF EMBODIMENTS OF THE PRESENT INVENTION

The present invention will now be described more fully with reference to the accompanying drawings, in which embodiments of the invention are shown.

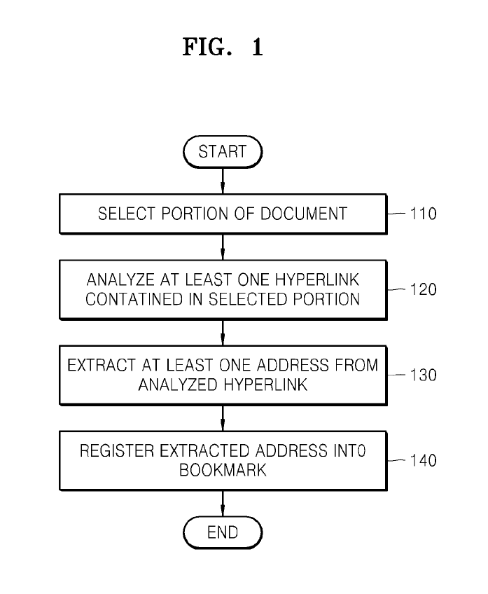

FIG. 1 is a flowchart illustrating a method of inserting an address of a hyperlink into a bookmark, according to an embodiment of the present invention.

Referring to FIG. 1, in step 110, a bookmark inserting apparatus selects a portion of a document, which may be a webpage. However, the document is not limited to a webpage, as long the document includes a hyperlink. A “hyperlink” denotes a link between an element, such as a single word, phrase, symbol, or image, in a hypertext document and another element in the same or another hypertext document. The hyperlink is also called a hypertext link or a hotlink. For example, the hyperlink may designate video, text, music, a picture, a program, a file, or a specific address of writing. This is a core concept of hyperlinking and is implemented in markup languages including the ubiquitous HyperText Markup Language (HTML). A user may enable or activate a hyperlink by clicking an underlined element in a hypertext document or an element (linked element) marked with a color different from that of the rest of the hypertext document. As such, a search may be performed by selecting a link between an element and another element in the same hypertext document or selecting a link between an element in a hypertext document and another element in a hypertext document in a World Wide Web (WWW) server of another Internet host. A hyperlink is inserted in a hypertext document by means of a tag of a document creation language, such as Standard Generalized Markup Language (SGML) or HTML. The hypertext indicates a text which is displayed in another document from a certain document via a reference (hyperlink) and is mainly displayed by computers or other home appliances.

A screen of the document may be divided into blocks. A user of the bookmark inserting apparatus may select a certain block that is the portion of the document. According to an embodiment of the present invention, a semantic block-based zooming technique of dividing a webpage into semantic blocks and zooming in a unit of a semantic block is provided. When the user selects a desired semantic block, the selected semantic block pops up and zooms in.

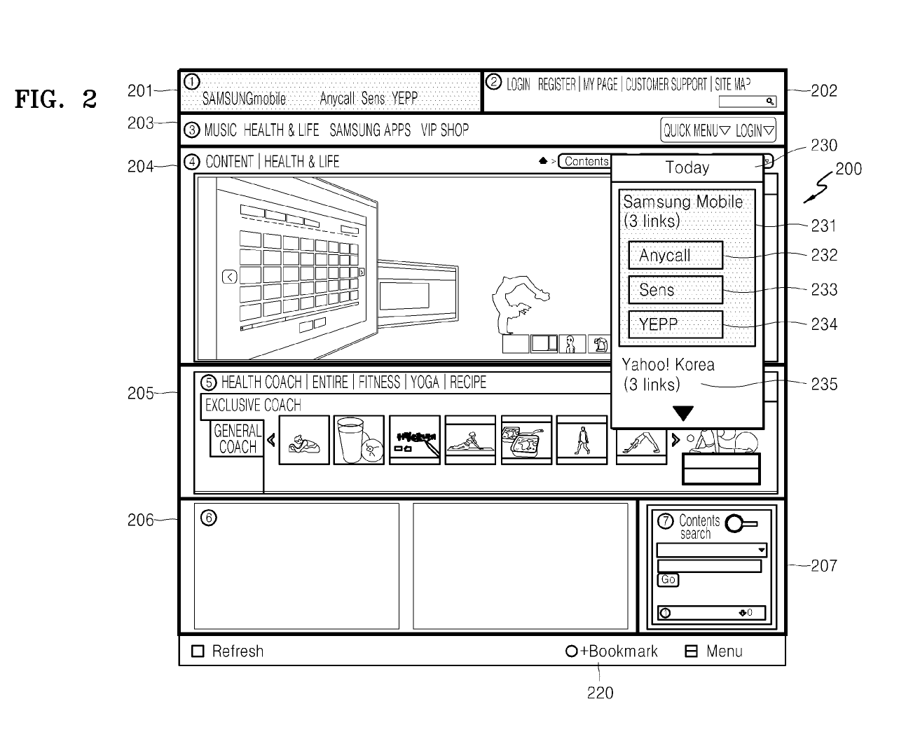

According to another embodiment of the present invention, the user selects a desired area. For example, the user may select a desired area by designating a block with an input device. This is described with reference to FIG. 2 as an example.

FIG. 2 shows an illustrative screen of a webpage 200, according to an embodiment of the present invention.

Referring to FIG. 2, the screen of the webpage 200 is divided into first to seventh areas 201 to 207. A portion, the first area 201 in FIG. 2, is selected by the user from among the first to seventh areas 201 to 207, thereby focusing the first area 201. The first area 201 includes three hyperlinks “Anycall,” (a Korean mobile phone brand) “Sens,” (a notebook computer series) and “YEPP” (a digital audio player brand). A bookmark button 220 for executing a bookmark function is also included in the webpage 200. When the user presses the bookmark button 220 in a state where the portion of the document is selected, the bookmark inserting apparatus proceeds to step 120 of FIG. 1.

In step 120, when the bookmark function is executed, the bookmark inserting apparatus analyzes at least one hyperlink contained in the selected portion. The bookmark inserting apparatus extracts a hyperlink included in the selected portion. There may be one or multiple hyperlinks extracted.

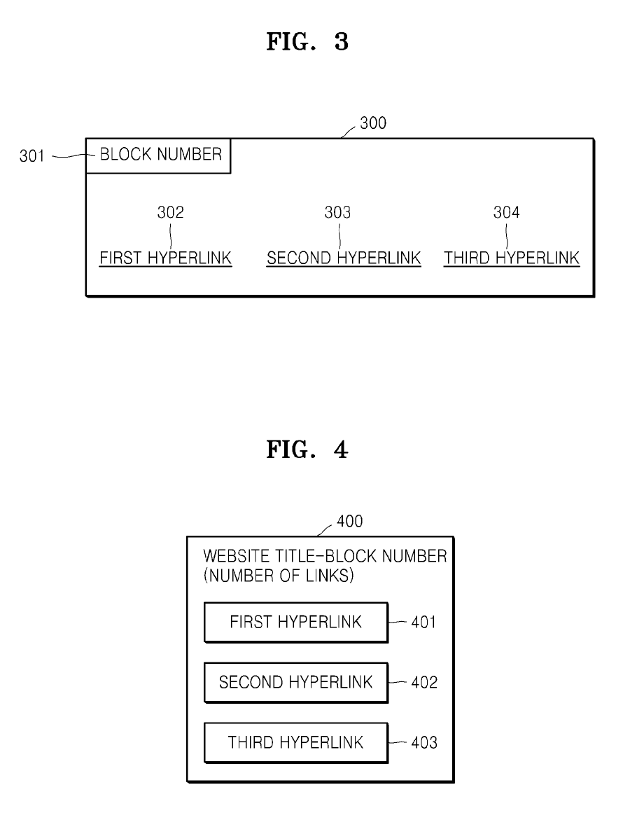

FIG. 3 illustrates a structure of a selected portion 300 including 3 hyperlinks 302 to 304, according to an embodiment of the present invention. Referring to FIG. 3, the selected portion 300 includes a block number 301 and the 3 hyperlinks 302 to 304. The block number 301 may be omitted in some cases. If the selected portion 300 corresponds to the first area 201 of FIG. 2, the hyperlinks 302 to 304 correspond to “Anycall,” “Sens,” and “YEPP,” respectively.

Referring back to FIG. 1, in step 130, the bookmark inserting apparatus extracts at least one address from the extracted hyperlink. That is, the bookmark inserting apparatus extracts a link address included in the extracted hyperlink. For example, an HTML tag of a hyperlink is generally formed with “<a href=”link address“>link</a>”. An HTML tag of the hyperlink “Anycall” is formed with “<a href=”http://kr.samsungmobile.com/product/anycall/product/main.do “>Anycall</a>,” wherein the bookmark inserting apparatus extracts “http://kr.samsungmobile.com/product/anycall/product/main.do” that is an address linked to the hyperlink “Anycall”. Additionally, the bookmark inserting apparatus may extract only at least one desired address according to a preset condition instead of extracting all the addresses from the extracted hyperlink. For example, the preset condition may be a user preference, a keyword previously input by the user, or the number of addresses, which is set by the user.

In step 140, the bookmark inserting apparatus inserts the extracted address into a bookmark. If only one hyperlink is extracted, the bookmark inserting apparatus inserts the extracted address into the bookmark with a predetermined title. For example, the bookmark inserting apparatus may insert a hypertext of the hyperlink including the extracted address into the bookmark as the title or insert the description of an image or an image filename of an image included in the selected portion in the bookmark as the title. The registration in the bookmark indicates that the bookmark is a part of a bookmark list.

If there are multiple hyperlinks extracted, the bookmark inserting apparatus groups the plurality of extracted addresses and inserts the group of the addresses into a single bookmark. The bookmark inserting apparatus inserts the group in the bookmark with a predetermined group title so that each of the extracted addresses is included in the group with a predetermined title. As a method of setting a group title, the bookmark inserting apparatus sets the group title based on information regarding the document (e.g., the webpage) and inserts the group title in the bookmark, or sets the group title based on a word (e.g., a block number, higher category information of the selected portion, etc.) representing the selected portion and inserts the group title into the bookmark. The group title of the bookmark may indicate the number of links, i.e., the number of extracted addresses. As a method of setting a title of an extracted address, the bookmark inserting apparatus may insert a hypertext of a hyperlink corresponding to the extracted address into the bookmark as the title or insert the image description information or an image filename of an image included in a selected portion in the bookmark as the title. In this case, a plurality of bookmarks may be grouped and inserted without opening a plurality of webpages by extracting a hyperlink in a portion of a webpage.

According to another embodiment of grouping, the bookmark inserting apparatus groups the plurality of extracted addresses and inserts a certain category of a bookmark in which a plurality of categories are previously set.

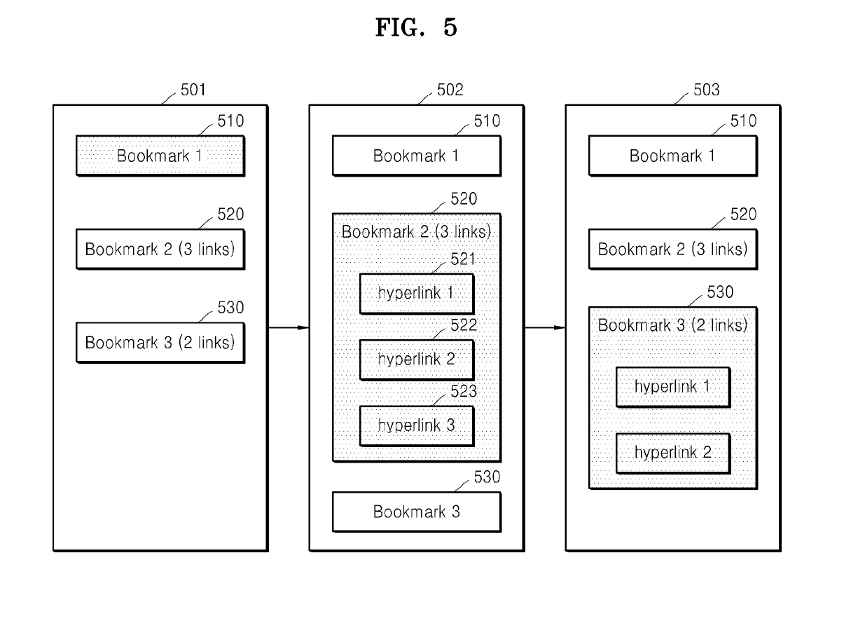

FIG. 4 illustrates a structure of a group 400 inserted in a bookmark, according to an embodiment of the present invention.

Referring to FIG. 4, “website title-block number (number of links)” is set in the group 400 as a group title, and the group 400 includes three hyperlinks 401, 402 and 403. A title of each of the hyperlinks 401, 402 and 403 may be set according to the preset condition.

Referring back to FIG. 2, when the user selects the first area 201 and presses the bookmark button 220, the bookmark inserting apparatus analyzes the hyperlinks “Anycall,” “Sens,” and “YEPP” in the first area 201, extracts addresses from the hyperlinks, and groups the extracted addresses. A bookmark inserting menu 230 is then activated, and groups 231 and 235 are displayed in the bookmark inserting menu 230. The title of a “Samsung Mobile” group 231 is set as webpage information “Samsung Mobile (3 links),” and titles of hyperlinks 232, 233 and 234 are respectively set as “Anycall,” “Sens,” and “YEPP” that are hypertexts of the hyperlinks 232, 233 and 234.

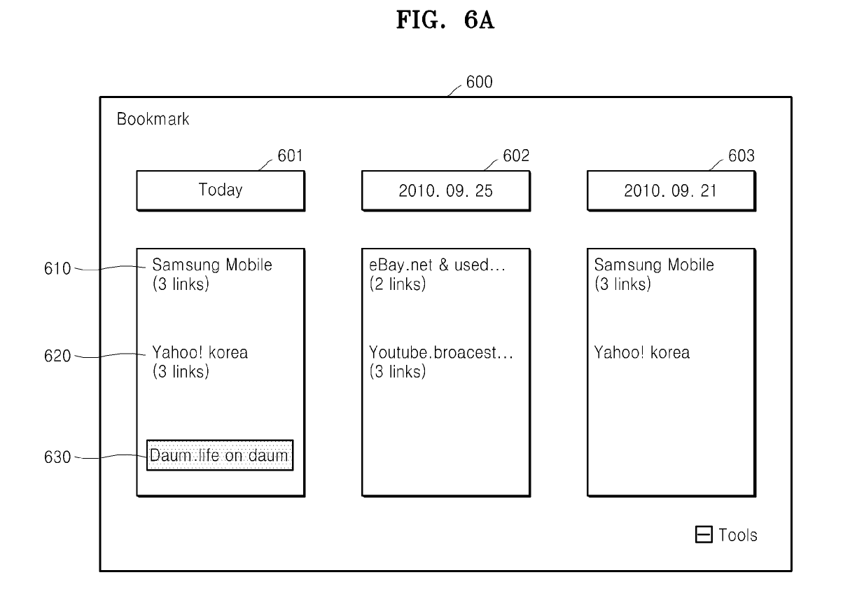

FIG. 5 illustrates bookmarks in which addresses of hyperlinks are inserted, according to an embodiment of the present invention.

Referring to FIG. 5, a first bookmark 510, a second bookmark 520, and a third bookmark 530 are inserted in bookmark lists 501, 502 and 503. A single hyperlink is inserted in the first bookmark 510, and a plurality of hyperlinks are grouped and inserted in the second bookmark 520 and the third bookmark 530. The first bookmark 510 is selected in the bookmark list 501. The second bookmark 520 is selected in the bookmark list 502. Since a plurality of hyperlinks are grouped and inserted in the second bookmark 520, when the second bookmark 520 is focused, all hyperlinks that are lower items of the group are displayed. The third bookmark 530 is similar to the second bookmark 520. When there is a single hyperlink, the user may select an individual bookmark to move to a linked address, and when there are a plurality of hyperlinks, the user may select an individual hyperlink included in a group to move to a linked address.

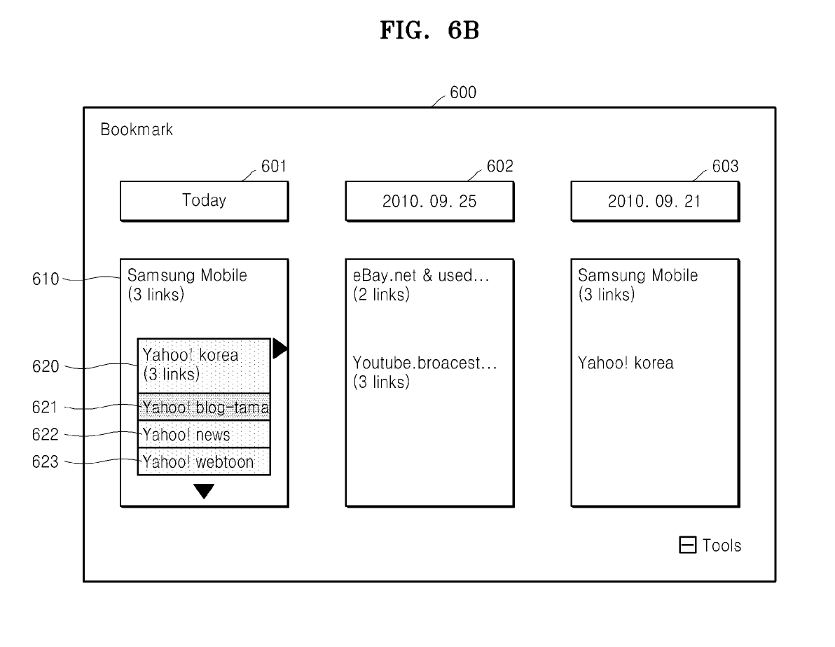

FIGS. 6A and 6B are illustrative diagrams of FIG. 5. Referring to FIGS. 6A and 6B, a bookmark list 600 includes date categories “Today” 601, “2010.09.25” 602, and “2010.09.21” 603. Hyperlinks are inserted in each category as bookmarks. The category “Today” 601 includes a bookmark 610 titled “Samsung Mobile,” a bookmark 620 titled “Yahoo!korea,” and a bookmark 630 titled “Daum.life on daum”. Each of the bookmark 610 titled “Samsung Mobile” and the bookmark 620 titled “Yahoo!korea” includes 3 hyperlinks grouped therein, and the bookmark 630 titled“Daum.life on daum” includes a single hyperlink. In FIG. 6A, the bookmark 630 titled“Daum.life on daum” in which a single hyperlink is inserted is focused, and when the bookmark 630 titled“Daum.life on daum” is activated, a document in an address of the inserted hyperlink pops up. In FIG. 6B, in the bookmark 620 titled “Yahoo!korea” in which a hyperlink “Yahoo! blog-tama” 621, a hyperlink “Yahoo! news” 622, and a hyperlink “Yahoo! webtoon” 633 are inserted, the hyperlink “Yahoo! blog-tama” 621 is focused, and when the hyperlink “Yahoo! blog-tama” 621 is activated, a document in an address of the hyperlink “Yahoo! blog-tama” 621 pops up.

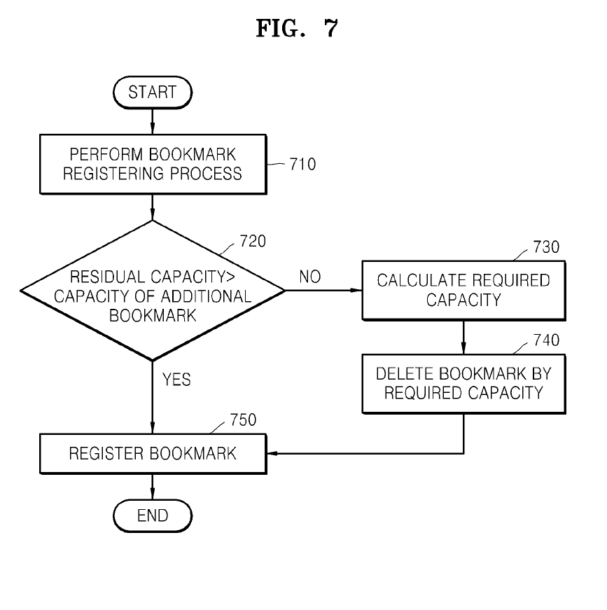

FIG. 7 is a flowchart illustrating a method of deleting a inserted bookmark, according to an embodiment of the present invention.

Referring to FIG. 7, in step 710, the bookmark inserting apparatus performs a bookmark inserting process.

In step 720, the bookmark inserting apparatus calculates a capacity of a bookmark to be inserted in the method of FIG. 1. Thereafter, the bookmark inserting apparatus compares the capacity of the bookmark to be inserted with a bookmark storage capacity remaining. If the capacity of the bookmark to be inserted is equal to or greater than the bookmark storage capacity remaining, the bookmark inserting apparatus proceeds to step 730, otherwise, if the capacity of the bookmark to be inserted is less than the bookmark storage capacity remaining, the bookmark inserting apparatus proceeds to step 750.

In step 730, the bookmark inserting apparatus calculates a required bookmark storage capacity. For example, when the capacity of the bookmark to be inserted is 2 MB and the bookmark storage capacity remaining is 1 MB, the required bookmark storage capacity is calculated as 1 MB.

In step 740, the bookmark inserting apparatus deletes a previously stored bookmark by the required bookmark storage capacity. A bookmark selected by the user may manually be deleted, or the oldest stored bookmark may be automatically deleted. As a method of deleting bookmarks selected by the user, when a device including the bookmark inserting apparatus supports a button input device, bookmarks may be grouped and deleted by a corresponding capacity, and when the device including the bookmark inserting apparatus supports a touch input device, bookmarks may be individually deleted by a corresponding capacity.

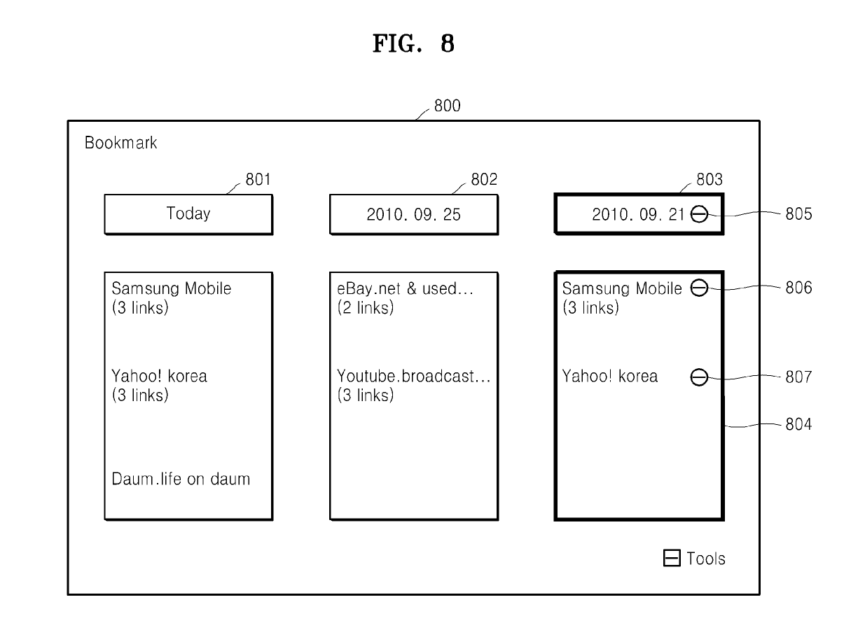

FIG. 8 illustrates a method of deleting a inserted bookmark, according to an embodiment of the present invention.

FIG. 8 has the same configuration as the bookmark list of FIG. 6A or 6B, showing a delete button 805 of a category “2010.09.21” 803 and delete buttons 806 and 807 of respective bookmarks 804. When the user presses the delete button 805 of the category “2010.09.21” 803, all bookmarks 804 included in the category “2010.09.21” 803 are deleted, and when the user presses each of the delete buttons 806 and 807 of the respective bookmarks 804, a corresponding bookmark is deleted.

Referring back to FIG. 7, in step 750, the bookmark inserting apparatus inserts the bookmark selected by performing the bookmark inserting process.

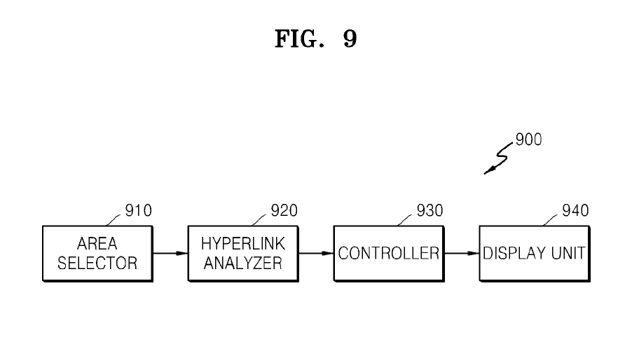

FIG. 9 is a block diagram of an apparatus 900 for inserting an address of a hyperlink into a bookmark, according to an embodiment of the present invention.

Referring to FIG. 9, the apparatus 900 includes an area selector 910, a hyperlink analyzer 920, a controller 930, and a display unit 940.

The area selector 910 selects a portion of a document. The document may be a webpage. However, the document is not limited to a webpage, so long as it contains a hyperlink. Since “hyperlink” and “hypertext” have been described with reference to FIG. 2, their repeated description is omitted.

A screen of the document may be divided into blocks. A user of the apparatus 900 may select a certain block, which is a portion of the document. According to an embodiment of the present invention, a semantic block-based zooming technique of dividing a webpage into semantic blocks and zooming in a unit of a semantic block may be provided. When the user selects a desired semantic block, the selected semantic block pops up and zooms in.

According to another embodiment of the present invention, the user may select a desired area. For example, the user may select a desired area by selecting a block with an input device.

When the bookmark function is executed, the hyperlink analyzer 920 analyzes at least one hyperlink included in the selected portion. The hyperlink analyzer 920 extracts a hyperlink included in the selected portion. There may be one or multiple hyperlinks. The hyperlink analyzer 920 extracts at least one address from the extracted hyperlink. That is, the hyperlink analyzer 920 extracts a link address contained in the extracted hyperlink. Additionally, the hyperlink analyzer 920 may extract at least one desired address according to a preset condition instead of extracting all addresses from the extracted hyperlink. For example, the preset condition may be a user preference, a keyword previously input by the user, or the number of addresses, which is set by the user.

The controller 930 inserts the extracted address into a bookmark. If there is only one hyperlink extracted, the controller 930 inserts the extracted address into the bookmark with a predetermined title. For example, the controller 930 may insert a hypertext of the hyperlink including the extracted address into the bookmark as the title or insert image description information or an image filename of an image included in the selected portion in the bookmark as the title. The insertion in the bookmark indicates that the bookmark is included in a bookmark list.

If there are multiple hyperlink extracted, the controller 930 groups the multiple extracted addresses and inserts the group of the addresses into the bookmark en bloc. The controller 930 inserts the group in the bookmark with a predetermined group title so that each of the extracted addresses is included in the group with a predetermined title. As a method of setting a group title, the controller 930 sets the group title based on information regarding the document (e.g., webpage) and inserts the group title in the bookmark, or sets the group title based on a word (e.g., a block number, higher category information of the selected portion, etc.) representing the selected portion and inserts the group title in the bookmark. The group title of the bookmark may indicate the number of links, i.e., the number of extracted addresses. As a method of setting a title of an extracted address, the controller 930 may insert a hypertext of a hyperlink corresponding to the extracted address into the bookmark as the title or insert image description information or an image filename of an image included in a selected portion in the bookmark as the title. A plurality of bookmarks may be grouped and inserted without opening a plurality of webpages by extracting a hyperlink in a portion of a webpage.

According to another embodiment of grouping, the controller 930 groups the plurality of extracted addresses and inserts a certain category of a bookmark in which a plurality of categories have been previously set.

The controller 930 calculates a capacity of a bookmark to be inserted and compares the capacity of the bookmark to be inserted with a bookmark storage residual capacity. If the capacity of the bookmark to be inserted is equal to or greater than the bookmark storage capacity remaining, the controller 930 calculates a required bookmark storage capacity. For example, when the capacity of the bookmark to be inserted is 2 MB and the bookmark storage capacity remaining is 1 MB, the required bookmark storage capacity is calculated as 1 MB. Thereafter, the controller 930 deletes a previously stored bookmark by the required bookmark storage capacity. A bookmark selected by the user may be manually deleted, or the oldest stored bookmark may be automatically deleted. As a method of deleting bookmarks selected by the user, when a device including the apparatus 900 supports a button input device, bookmarks may be grouped and deleted by a corresponding capacity, and when the device including the apparatus 900 supports a touch input device, bookmarks may be individually deleted by a corresponding capacity.

The display unit 940 displays the bookmark list.

The method of inserting an address of a hyperlink into a bookmark can also be embodied as computer-readable codes on a computer-readable storage medium. The computer-readable recording medium is any data recording medium that can store data which can be thereafter read by a computer system. Examples of the computer-readable recording medium include Read-Only Memory (ROM), Random-Access Memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments for accomplishing the present invention can be easily construed by programmers skilled in the art to which the present invention pertains.

While this invention has been particularly shown and described with reference to embodiments thereof, it will be understood by those skilled in the art that various changes in form and details may be made therein without departing from the spirit and scope of the invention as defined by the appended claims and their equivalents.

What is claimed is:

1. A method of inserting an address of a hyperlink into a bookmark, the method comprising:
selecting a portion of a document;
analyzing a plurality of hyperlinks contained in the selected portion of the document;
extracting at least one address from the analyzed hyperlinks; and
inserting the extracted addresses into the bookmark.

2. The method of claim 1, wherein inserting the extracted addresses into the bookmark includes grouping the extracted addresses and inserting the group of addresses into the bookmark.

3. The method of claim 2, wherein grouping the extracted addresses and the inserting the group of addresses into the bookmark includes inserting information regarding the document into the bookmark as a title of the group of addresses.

4. The method of claim 2, wherein grouping the extracted addresses and the inserting the group of addresses into the bookmark includes inserting a word representing the selected portion into the bookmark as a title of the group of addresses.

5. The method of claim 2, wherein grouping the extracted addresses and the inserting the group of addresses into the bookmark includes inserting the extracted addresses into the bookmark so that each of the extracted addresses is included in the group of addresses by using a hypertext of a hyperlink corresponding to the extracted address as a title.

6. The method of claim 2, wherein grouping the extracted addresses and the inserting the group of addresses into the bookmark includes inserting the extracted addresses into the bookmark so that each of the extracted addresses is included in the group of addresses by using image description information or an image filename of an image included in the selected portion as a title.

7. The method of claim 1, wherein extracting the at least one address from the analyzed hyperlinks includes extracting at least one address according to a preset condition from the analyzed hyperlinks.

8. The method of claim 7, wherein the preset condition is a user preference.

9. The method of claim 2, wherein grouping the extracted addresses and the inserting the group of addresses into the bookmark comprises:
grouping the extracted addresses; and
inserting the group of addresses in a certain category in the bookmark in which a plurality of categories are set.

10. The method of claim 1, further comprising:
if inserting the extracted addresses into the bookmark exceeds the capacity of the bookmark, deleting at least one address inserted in the bookmark.

11. An apparatus for inserting an address of a hyperlink into a bookmark, the apparatus comprising:
an area selector for selecting a portion of a document;
a hyperlink analyzer for analyzing a plurality of hyperlinks contained in the selected portion and extracting at least one address from the analyzed hyperlinks; and
a controller for inserting the extracted addresses into the bookmark.

12. The apparatus of claim 11, wherein the controller groups the extracted addresses and inserts the group of addresses into the bookmark.

13. The apparatus of claim 12, wherein the controller inserts information regarding the document into the bookmark as a title of the group of addresses.

14. The apparatus of claim 12, wherein the controller inserts a word representing the selected portion into the bookmark as a title of the group of addresses.

15. The apparatus of claim 12, wherein the controller inserts the extracted addresses into the bookmark so that each of the extracted addresses is included in the group of addresses by using a hypertext of a hyperlink corresponding to the extracted address as a title.

16. The apparatus of claim 11, wherein the controller inserts the extracted addresses into the bookmark so that each of the extracted addresses is included in the group of addresses by using image description information or an image filename of an image included in the selected portion as a title.

17. The apparatus of claim 11, wherein the hyperlink analyzer extracts at least one address according to a preset condition from the analyzed hyperlinks.

18. The apparatus of claim 17, wherein the preset condition is a user preference.

19. The apparatus of claim 12, wherein the controller groups the extracted addresses and inserts the group of addresses in a certain category in the bookmark in which a plurality of categories are set.

20. The apparatus of claim 11, wherein, if inserting the extracted addresses into the bookmark exceeds the capacity of the bookmark, the controller deletes at least one address inserted in the bookmark.
